(19) United States
(12) Patent Application Publication
(10) Pub. No.: US 2026/0300391 A1
(43) Pub. Date: Oct. 1, 2026

(54) METHOD, DEVICE, AND MEDIUM FOR RESPONSE PROVISIONING

(71) Applicant: Beijing Zitiao Network Technology Co., Ltd., Beijing (CN)

(72) Inventors: Xuan Li, Beijing (CN); Yutong Zhao, Beijing (CN); Zhekai Ye, Beijing (CN)

(21) Appl. No.: 19/430,779

(22) Filed: Dec. 23, 2025

(30) Foreign Application Priority Data
Mar. 31, 2025 (CN) 202510400558.7

(51) Int. Cl. G06F 16/732; G06F 9/451; G06F 16/71; G06V 10/70; G06V 10/94; G06V 20/40; G10L 15/22; G10L 15/30

(52) U.S. Cl. CPC G06F 16/732; G06F 9/453; G06F 16/71; G06V 10/70; G06V 10/95; G06V 20/46; G10L 15/22; G10L 15/30

(57) ABSTRACT

The present disclosure provides a solution for response provisioning. A method includes: capturing a query speech and a video during an interaction process; determining a waiting policy for the query speech and the video based on a relative temporal relationship between an end of the capturing of the query speech and an end of the capturing of the video; providing the captured query speech and the captured video to a target machine learning model upon an end of waiting indicated by the waiting policy; and obtaining a response to the query speech, the response being determined based on at least a model output of the target machine learning model.

### CROSS-REFERENCE

The present application claims priority to Chinse Patent Application No. 202510400558.7, filed on Mar. 31, 2025, entitled “METHOD, APPARATUS, DEVICE, MEDIUM AND PROGRAM PRODUCT FOR RESPONSE PROVISIONING”, THE DISCLOSURES OF

which are incorporated herein by reference in their entireties.

### FIELD

Example embodiments of the present disclosure generally relate to the field of computers, and in particular, to a method, an apparatus, an electronic device, a computer-readable storage medium and a computer program product for response provisioning.

### BACKGROUND

With the development of information technology, various terminal devices may provide various services for people in work and life. For example, an application that provides services may be deployed on a terminal device. The terminal device or the application may provide a digital assistant-type function for a user to assist the user in using the terminal device or the application. The user may perform various operations through various interactions with the digital assistant.

### SUMMARY

In a first aspect of the present disclosure, a method for response provisioning is provided. The method includes: capturing a query speech and a video during an interaction process; determining a waiting policy for the query speech and the video based on a relative temporal relationship between an end of the capturing of the query speech and an end of the capturing of the video; providing the captured query speech and the captured video to a target machine learning model upon an end of waiting indicated by the waiting policy; and obtaining a response to the query speech, the response being determined based on at least a model output of the target machine learning model.

In a second aspect of the present disclosure, an apparatus for response provisioning is provided. The apparatus includes: a capturing module configured to capture a query speech and a video during an interaction process; a determination module configured to determine a waiting policy for the query speech and the video based on a relative temporal relationship between an end of the capturing of the query speech and an end of the capturing of the video; a providing module configured to provide the captured query speech and the captured video to a target machine learning model upon an end of waiting indicated by the waiting policy; and an obtaining module configured to obtain a response to the query speech, the response being determined based on at least a model output of the target machine learning model.

In a third aspect of the present disclosure, an electronic device is provided. The electronic device includes: at least one processing unit; and at least one memory, the at least one memory being coupled to the at least one processing unit and storing instructions executable by the at least one processing unit, the instructions, when executed by the at least one processing unit, causing the electronic device to perform the method according to the first aspect of the present disclosure.

In a fourth aspect of the present disclosure, a computer-readable storage medium is provided. The computer-readable storage medium stores a computer program which, when executed by a processor, causes the processor to perform the method according to the first aspect of the present disclosure.

In a fifth aspect of the present disclosure, a computer program product is provided. The computer program product is tangibly stored in a computer storage medium and includes computer-executable instructions which, when executed by a device, cause the device to perform the method of the first aspect.

It should be understood that the content described in this section is not intended to identify key or important features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments of the present disclosure can be implemented;

FIG. 2 shows a flowchart of a process for response provisioning according to some embodiments of the present disclosure;

FIG. 3A shows an example of an information capturing interface according to some embodiments of the present disclosure;

FIG. 3B shows an example according to some embodiments of the present disclosure;

FIG. 4 shows an example for response provisioning according to some embodiments of the present disclosure;

FIG. 5 shows an example structural block diagram of an apparatus for response provisioning according to some embodiments of the present disclosure; and

FIG. 6 shows a block diagram of an electronic device that can implement one or more embodiments of the present disclosure.

### DETAILED DESCRIPTION

The embodiments of the present disclosure will be described in more detail below with reference to the drawings. Although certain embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only used for example purposes, and are not used to limit the protection scope of the present disclosure.

In the description of the embodiments of the present disclosure, the terms “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performing a step does not mean that the step is performed immediately after “A”, but may include one or more intermediate steps.

It may be understood that the data involved in the technical solution (including but not limited to the data itself, capturing, use, storage or deletion of the data) should comply with the requirements of corresponding laws, regulations and related provisions.

It may be understood that before using the technical solutions disclosed in the embodiments of the present disclosure, the user should be informed of the type, range of use, use scenarios, etc. of personal information involved in the present disclosure and the authorization of the user should be obtained in an appropriate manner in accordance with relevant laws and regulations.

For example, in response to receiving an active request from a user, prompt information is sent to the user to clearly prompt the user that the requested operation will require access to and use of the user's personal information, so that the user may independently choose whether to provide the personal information to software or hardware, such as an electronic device, an application, a server or a storage medium, that performs the operations of the technical solutions of the present disclosure based on the prompt information.

As an optional but non-restrictive implementation, in response to receiving the active request from the user, the prompt information may be sent to the user in the form of, for example, a pop-up window, in which the prompt information may be presented in text. In addition, the pop-up window may also include a selection control for the user to select “agree” or “disagree” to provide the personal information to the electronic device.

It may be understood that the above process of notifying and obtaining user authorization is only illustrative and does not limit the implementations of the present disclosure. Other manners that satisfy the relevant laws and regulations may also be applied to the implementations of the present disclosure.

As used herein, the term “model” may learn a correlation between respective inputs and outputs from training data, so that a corresponding output may be generated for a given input after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, the “model” may also be referred to as a “machine learning model”, a “learning model”, a “machine learning network” or a “learning network”, which terms are used interchangeably herein.

A “neural network” is a machine learning network based on deep learning. A neural network may process an input and provide a corresponding output, and it generally includes an input layer and an output layer, as well as one or more hidden layers between the input layer and the output layer. Neural networks used in deep learning applications typically include many hidden layers, thereby increasing the depth of the network. The layers of the neural network are connected in sequence, so that an output of a previous layer is provided as an input of a next layer. The input layer receives the input of the neural network, and an output of the output layer is used as a final output of the neural network. Each layer of the neural network includes one or more nodes (also referred to as processing nodes or neurons), and each node processes the input from an upper layer.

Generally, machine learning may roughly include three stages, namely, a training stage, a testing stage and an application stage (also referred to as an inference stage). In the training stage, a given model may be trained using a large amount of training data, and a parameter value may be continuously updated through iteration until the model may obtain consistent inference that satisfies an expected objective from the training data. Through training, the model may be considered to be able to learn a correlation (also referred to as a mapping from input to output) from input to output from the training data. The parameter value of the trained model is determined. In the testing stage, a test input is applied to the trained model to test whether the model may provide a correct output, thereby determining the performance of the model. The testing stage may sometimes be incorporated into the training stage. In the application or inference stage, the trained model may be used to process an actual model input based on the parameter value obtained through training, to determine a corresponding model output.

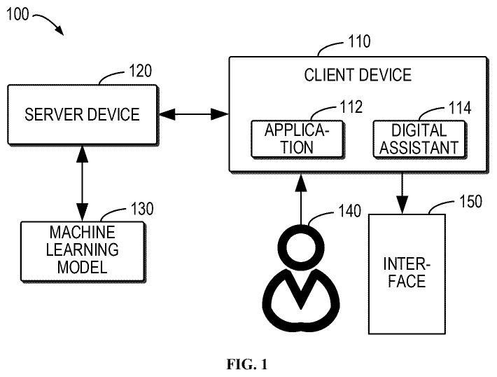

FIG. 1 shows a schematic diagram of an example environment 100 in which the embodiments of the present disclosure can be implemented. In this example environment 100, an application 112 and a digital assistant 114 are installed on a client device 110. A user 140 may interact with the application 112 via the client device 110 and/or an attachment device of the client device 110. In some implementations, the application 112 may be authorized to capture a speech via an audio capturing device (such as a microphone) of the client device 110, capture an image via an image capturing device (such as a camera) of the client device 110, and so on.

In some embodiments, the application 112 and the digital assistant 114 may be downloaded and installed on the client device 110. In some embodiments, the application 112 and the digital assistant 114 may also be accessed in other manners, such as via a web page.

In the embodiments of the present disclosure, the application 112 may be any appropriate application having a response function, which may include, but is not limited to, one or more of the following: a chat application component (also referred to as an instant messaging application component), a browser application component, a planning application component, a document application component, an audio and video conference application component, an email application component, a task application component, a calendar application component, an objective and key result (OKR) application component, and so on. It may be understood that although a single application is shown in FIG. 1, multiple applications may actually be installed on the client device 110. In some embodiments, the application 112 may include a multi-functional collaboration platform, for example, an office collaboration platform (also referred to as an office suite) may provide an integration of multiple types of business components to facilitate people's office, communication and other activities. In the multi-functional collaboration platform, people may start different business components as needed to complete corresponding information processing, sharing, communication, etc.

In some embodiments, the digital assistant 114 may be provided by a separate application, or may be integrated in a certain application 112 that may provide a content entity. The application business component used to provide the client interface of the digital assistant may correspond to a single function application business component or a multi-functional collaboration platform, such as an office suite or other collaboration platforms that may integrate multiple components. It may be understood that, similar to the application, although a single digital assistant is shown in FIG. 1, there may actually be multiple digital assistants.

In some embodiments, the digital assistant 114 supports the use of plugins. Each plugin may provide one or more functions of the application. Such plugins include, but are not limited to, one or more of the following: a search plugin, a contact plugin, a message plugin, a document plugin, a table plugin, an email plugin, a calendar plugin, a schedule plugin, a task plugin, and so on.

The digital assistant 114 is an intelligent assistant of the user, which has intelligent conversation and information processing capabilities. In the embodiments of the present disclosure, the digital assistant 114 is configured to interact with the user 140 to assist the user 140 in using the client device 110 or the application 112. In some embodiments, multiple interaction modes between the user 140 and the digital assistant 114 may be provided, and flexible switching between the multiple interaction modes is possible. In the case that a certain interaction mode is triggered, a corresponding interaction region is presented to facilitate the interaction between the user 140 and the digital assistant 114. The interaction manners between the user 140 and the digital assistant 114 in different interaction modes are different, which may flexibly adapt to interaction requirements in different application scenarios.

In the environment 100, in response to the application 112 and/or the digital assistant 114 being launched, the client device 110 may present an interface 150 of the application 112 and/or the digital assistant 114. The interface 150 may include, for example, an interaction interface of the application 112 and the digital assistant 114. In some embodiments, an interaction window between the user 140 and the digital assistant 114 may be presented in the interface 150. In the interaction window, the user 140 may chat with the digital assistant 114 by inputting information in a natural language, a picture, an audio file, a video file, a web page file, etc., to instruct the digital assistant to assist in completing various tasks.

The interaction window between the digital assistant 114 and the user 140 may include a chat window, such as a chat window in an instant messaging application or an instant messaging module of a specific application. In the chat window, the interaction between the digital assistant 114 and the user 140 may be presented in the form of chat messages. Alternatively or additionally, the interaction window between the digital assistant 114 and the user 140 may further include other types of windows, such as a window in a floating window mode, in which the user 140 may trigger the digital assistant 114 to perform corresponding operations by inputting instructions, selecting quick instructions, etc.

In some embodiments, the digital assistant 114 may support an interaction mode of a chat window, which is also referred to as a chat mode. In this interaction mode, a chat window between the user 140 and the digital assistant 114 is presented, in which the user 140 and the digital assistant 114 interact through chat messages. In the chat mode, the digital assistant 114 may perform tasks based on the chat messages in the chat window. In the interaction window, the user 140 inputs an interaction message, and the digital assistant 114 provides a reply message in response to the user input. By selecting the digital assistant 114, the chat window with the digital assistant 114 may be provided. The chat window may include interface elements for information exchange, such as an input box, a message list, message bubbles, and so on.

In some embodiments, a communication connection is established between the client device 110 and a server device 120. The communication connection may be established in a wired or wireless manner. The communication connection may include, but is not limited to, a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the client device 110 and the server device 120 may implement signaling interaction through the communication connection therebetween, so as to implement the provision of the services of the application 112 and/or the digital assistant 114.

As shown in FIG. 1, the server device 120 may invoke a machine learning model 130 to support the response function of the application 112 based on an output of the machine learning model 130. The machine learning model 130 may be based on any appropriate model structure, including but not limited to a transformer model, a convolutional neural network (CNN), a recurrent neural network (RNN), a deep neural network (DNN), and so on. In some embodiments, the machine learning model 130 may be based on a language model (LM). The language model may acquire a question and answering capability by learning from a large amount of corpus. The machine learning model 130 may also be based on other appropriate models.

The machine learning model 130 may be deployed on the server device 120 or on other devices. The machine learning model 130 may include one or more machine learning models. It should be noted that if the machine learning model 130 includes multiple machine learning models, the multiple machine learning models may have different structures, purposes and functions, which is not limited by the present disclosure. It should be noted that a machine learning model may also be deployed locally on the client device 110, and the client device 110 may also directly invoke the local machine learning model to support the response function of the application 112 based on an output of the local machine learning model.

The client device 110 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including the accessories and peripherals of these devices or any combination thereof. In some embodiments, the client device 110 may also support any type of interface for the user (such as “wearable” circuitry, etc.).

The server device 120 may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server device 120 may include, for example, a computing system/server, such as a mainframe, an edge computing node, a computing device in a cloud environment, and so on.

It should be understood that the structures and functions of various elements in the environment 100 are described only for the purpose of illustration, without suggesting any limitation on the scope of the present disclosure.

As mentioned above, the user may complete various operations through various interactions with the digital assistant. The user may provide user input of at least one modality to the digital assistant, and the digital assistant may then determine a corresponding response based on the received user input. The user input may include a speech and a video. Since the trigger and end times of speech capturing and video capturing may be different, and the user may trigger the capturing of speech and video multiple times during the interaction, it is difficult to determine the basis for the response. If an irrelevant speech or an irrelevant video is utilized in determining the response, the final response may not meet the expectations of the user.

In view of this, according to the embodiments of the present disclosure, an improved solution for response provisioning is provided. In the solution according to the embodiments of the present disclosure, a query speech and a video are captured during an interaction process. A waiting policy for the query speech and the video is determined based on a relative temporal relationship between an end of the capturing of the query speech and an end of the capturing of the video. The captured query speech and the captured video are provided to a target machine learning model upon an end of waiting indicated by the waiting policy. A response to the query speech is obtained, where the response is based on at least a model output of the target machine learning model.

In this way, in a multimodal response process, the waiting policy for the query speech and the video may be determined based on the relative temporal relationship between the end of the capturing of the query speech and the end of the capturing of the video. When the waiting policy indicates an end of waiting, the target machine learning model may be used to determine the response to the query speech based on the captured query speech and the captured video. This may ensure a correlation between the captured video and the query speech, as well as respective integrities of the used video and the used query speech, thereby improving the efficiency and quality of the response.

Some example embodiments of the present disclosure will be described below with continued reference to the drawings.

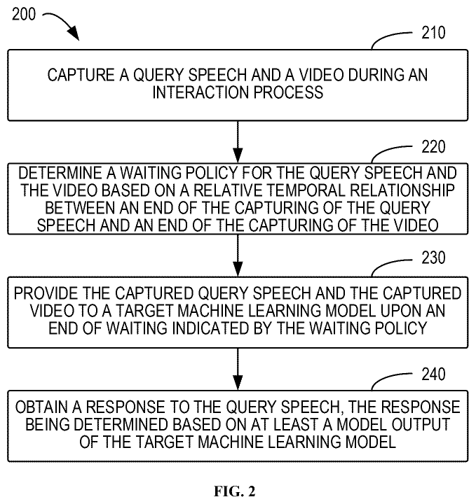

FIG. 2 shows a flowchart of a process 200 for response provisioning according to some embodiments of the present disclosure. For the convenience of discussion, the process 200 will be described with reference to the environment 100 of FIG. 1. The process 200 may be implemented at the client device 110 and/or the server device 120. For the convenience of description, the process 200 is implemented at the client device 110 as an example for description. It should be noted that the operations performed by the client device 110 may be specifically performed by a related application and/or the digital assistant installed on the client device 110.

It should be noted that if the process 200 is implemented at the server device 120 as an example for description, the server device 120 needs to receive data from the client device 110 and send data to the client device 110 via the communication connection with the client device 110. Similarly, it may be understood that some operations described with reference to the client device 110 may require the assistance of the server device 120 to complete.

At block 210, the client device 110 captures a query speech and a video during an interaction process.

For example, the client device 110 may capture the query speech and the video during an interaction process between a user (for example, the user 140) and a digital assistant (for example, the digital assistant 114). For example, the client device 110 may directly start the capturing of the query speech and the video in response to the start of the interaction process. For example, the client device 110 may further provide prompt information to the user in response to the start of the interaction process, where the prompt information may prompt the user that the query speech and the video will be captured. For example, the client device 110 may further provide a confirmation control together with the prompt information, and may start the capturing of the query speech and the video in response to receiving a trigger on the confirmation control.

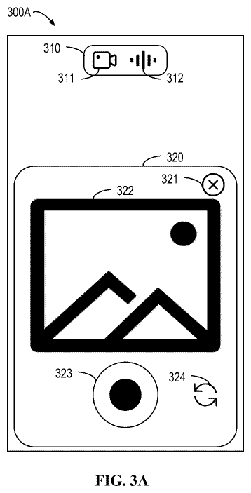

In some embodiments, the client device 110 may further provide an information capturing interface (which may also be referred to as a data capturing interface, an input interface, an interaction interface, etc.). Reference is made to FIG. 3A, which shows an example 300A of an information capturing interface according to some embodiments of the present disclosure. As shown in FIG. 3A, the example 300A includes an area 310. The area 310 includes a multimodal capturing control 311 and a speech capturing control 312. The client device 110 may switch to a speech capturing state in response to receiving a trigger on the speech capturing control 312, and keep capturing speech in the speech capturing state.

The client device 110 may further present a framing interface 320 in response to receiving a trigger on the multimodal capturing control 311. The client device 110 may turn on an image capturing device (such as a camera) in response to the framing interface 320 being presented, and present a video that can be captured via the camera in an area 322. The framing interface 320 may further include a shooting control 323. The client device 110 may switch to a video capturing state in response to receiving a trigger on the shooting control 323, and capture a video in the video capturing state.

The client device 110 may, for example, further stop the capturing of the video in response to a stopping trigger on the shooting control 323 or in response to receiving a second-time trigger on the shooting control 323. For example, the client device 110 may determine that the trigger on the shooting control is received in response to receiving a long press operation on the shooting control 323, and start capturing a video. The client device 110 may then stop capturing the video in response to the end of the long press operation on the shooting control 323. For another example, the client device 110 may determine that the trigger on the shooting control is received in response to receiving a click operation on the shooting control 323, and start capturing a video. The client device 110 may then stop capturing the video in response to receiving a click operation on the shooting control 323 again.

In some embodiments, the client device 110 may present the shooting control 323 in different visual styles when it is in the video capturing state and when it is not in the video capturing state. As an example, the client device 110 may present the shooting control 323 in the visual style shown in the example 300A when it is not in the video capturing state, and may present the shooting control 323 in visual styles such as with an additional outer frame, a reduced size, and highlighted when it is in the video capturing state. It may be understood that the client device 110 may present the shooting control 323 in any appropriate visual style, and the specific visual style may be determined based on user settings, system settings, or application environment, etc., and the present disclosure does not limit the specific visual style.

It may be understood that in the case that the client device 110 is not in the video capturing state, the content presented in the area 322 is only the content that may be captured by the camera, and it has not been captured by the camera. In the case that the client device 110 is in the video capturing state, the content presented in the area 322 is the captured video.

In some embodiments, the framing interface 320 may further include a cancel control 321. No matter whether the client device 110 is currently in the video capturing state or not, the client device 110 may cancel presentation of the content captured by the camera in response to receiving a trigger on the cancel control 321. If the client device 110 is currently in the video capturing state, the client device 110 may exit the video capturing state and may not present the framing interface 320 in response to receiving the trigger on the cancel control 321. In some embodiments, in the case of presenting the framing interface 320, the client device 110 may cancel presentation of the framing interface 320 in response to receiving the trigger on the multimodal capturing control 311 again.

In some embodiments, in the case that multiple cameras are included, the framing interface 320 may further include a lens switching control 324. The client device 110 may switch the camera currently in use in response to receiving a trigger on the lens switching control 324. As an example, if the client device 110 includes a front-facing camera and a rear-facing camera, and the rear-facing camera is currently in use, the content that may be captured by the rear-facing camera may be presented in the area 322. The client device 110 may switch to use the front-facing camera in response to receiving the trigger on the lens switching control 324, and the content that is captured by the front-facing camera may be presented in the area 322.

At block 220, the client device 110 determines a waiting policy for the query speech and the video based on a relative temporal relationship between an end of the capturing of the query speech and an end of the capturing of the video. At block 230, the client device 110 provides the captured query speech and the captured video to a target machine learning model upon an end of waiting indicated by the waiting policy. The target machine learning model may be based on any appropriate model structure, and as an example, it may be based on a multimodal large language model (such as a visual language model VLM).

In some embodiments, the client device 110 may pre-determine a plurality of capturing scenarios associated with the query speech and the video, and determine different waiting policies for the plurality of capturing scenarios. It may be understood that different scenarios may correspond to the same waiting policy, or different scenarios may correspond to different waiting policies, which is not limited in the present disclosure. Each time the client device 110 captures a query speech and a video, it may determine a capturing scenario matching a current situation from the plurality of capturing scenarios based on the relative temporal relationship between the end of the capturing of the query speech and the end of the capturing of the video, and then determine a waiting policy corresponding to the capturing scenario as the waiting policy for the current query speech and the current video. For example, the client device 110 may construct a relation table of capturing scenarios and waiting policies. After determining the capturing scenario, the corresponding waiting policy may be searched for from the relation table.

Referring to FIG. 3B, FIG. 3B shows an example 300B according to some embodiments of the present disclosure. Blocks 301 to 306 in the example 300B show six examples of the capturing scenario. The horizontal direction of a rectangle in a block may represent time, and the left and right edges of the rectangle may represent the start of capturing and an end of the capturing, respectively. As shown in the block 301, the time to start capturing a query speech segment A is earlier than the time to start capturing a video segment A, and the capturing of the query speech segment A ends earlier than the capturing of the video segment A. If the relative temporal relationship between the end of the capturing of the query speech and the end of the capturing of the video matches the capturing scenario shown in the block 301, the client device 110 may determine that the waiting policy for the query speech and the video is the waiting policy corresponding to the capturing scenario shown in the block 301.

Regarding the specific manner of determining the waiting policy and providing the data to the target machine learning model, in some embodiments, the client device 110 may determine a first waiting policy in response to the capturing of a first query speech segment having ended before the capturing of a first video segment ends. The first waiting policy indicates waiting for a predetermined time (for example, 1 second as shown in the figure) after the video capturing ends. It may be understood that the predetermined time may be any appropriate time, for example, it may be 1 second, 2 seconds, 3 seconds, and so on. Waiting for the predetermined time helps to ensure the integrity of the video.

It may be understood that the target machine learning model may be a local machine learning model or a machine learning model at the server device 120. In some embodiments, since the data volume of a video is usually larger than that of an audio, the predetermined time here may be determined based on the historical time-consuming of storing a video, the historical time-consuming of uploading a video to the server device 120, and so on. For example, if the client device 110 usually needs 0.5 seconds to send the captured video to the server device 120 after the video capturing ends, the predetermined time may be 1 second. Waiting for the predetermined time after the video capturing ends may ensure that the video is completely stored or completely uploaded, which can ensure the integrity of the video obtained by the target machine learning model, and thus improve the accuracy of the response.

In some embodiments, the client device 110 may start to wait after the capturing of the first video segment ends according to the first waiting policy. The client device 110 may determine that the current capturing scenario still matches the capturing scenario shown in the block 301 and keep providing the captured first query speech segment and the captured first video segment to the target machine learning model according to the first waiting policy in response to the waiting time after the capturing of the first video segment ends reaching the predetermined time and determining that no second query speech segment or second video segment is being captured.

In some embodiments, the client device 110 may further start to wait after the capturing of the first video segment ends according to the first waiting policy. The client device 110 may determine a second waiting policy in response to detecting that a second query speech segment is being captured before a waiting time after the capturing of the first video segment ends reaches the predetermined time and determining that no second video segment is being captured at an end of the capturing of the second query speech segment. The second waiting policy indicates no waiting after the speech capturing ends. The client device 110 may provide, according to the second waiting policy, the captured first query speech segment, the captured second query speech segment and the captured first video segment to the target machine learning model after the end of the capturing of the second query speech segment. Therefore, if the query speech is captured again within the predetermined time after the video capturing, the client device 110 may wait until the query speech capturing ends before providing all the captured query speech and video to the machine learning model, which may ensure the integrity of the captured query speech.

In some embodiments, the client device 110 may further start to wait after the end of the capturing of the first video segment according to the first waiting policy, and determine a third waiting policy in response to detecting that a second video segment is being captured before the waiting time after the end of the capturing of the first video segment reaches the predetermined time, where the third waiting policy indicates interrupting the waiting for the predetermined time at a start of the capturing of the second video segment. The client device 110 may provide the captured first query speech segment and the captured first video segment to the target machine learning model at the start of the capturing of the second video segment according to the third waiting policy. Therefore, the first query speech segment and the first video segment whose capturing times match may be provided to the target machine learning model, which may ensure the correlation between the video and the query speech. By interrupting the waiting time after the video capturing, it may improve the efficiency of transmitting data to the model and help improve the efficiency of the response.

As an example, referring to FIG. 3B, in the case that the end of the capturing of the video segment A is later than the end of the capturing of the query speech segment A, the client device 110 may first determine that the current capturing scenario matches the capturing scenario shown in the block 301. In the capturing scenario shown in the block 301, the client device 110 starts waiting after the capturing of the video segment A ends according to the corresponding first waiting policy, and provides the query speech segment A and the video segment A to the target machine learning model in response to the end of 1s waiting (that is, the time corresponding to the dotted line in the block 301 is reached).

If the capturing of a query speech segment B (that is, the second query speech segment) is detected before the waiting time from the end of the capturing of the video segment A reaches the predetermined time, and it is determined that no video segment B (that is, the second video segment) is being captured at the end of the capturing of the query speech segment B, the client device 110 may determine that the current capturing scenario matches the capturing scenario shown in the block 302. In the capturing scenario shown in the block 302, the client device 110 may provide the query speech segment A, the query speech segment B and the video segment A to the target machine learning model in response to the end of the capturing of the query speech segment B (that is, the time corresponding to the dotted line in the block 302) according to the corresponding second waiting policy.

If the capturing of the video segment B is detected before the waiting time after the capturing of the video segment A ends reaches the predetermined time, the client device 110 may determine that the current capturing scenario matches the capturing scenario shown in the block 303. In the capturing scenario shown in the block 303, the client device 110 may directly provide the query speech segment A and the video segment A to the target machine learning model in response to the start of the capturing of the video segment B (that is, the time corresponding to the dotted line in the block 303) according to the third waiting policy.

In some embodiments, if the capturing of the first video segment has ended before the capturing of the first query speech segment ends, the capturing of the first query speech segment has not ended when the waiting time after the capturing of the first video segment ends reaches the predetermined time, and it is determined that no second video segment is being captured at the end of the capturing of the first query speech segment, then the client device 110 may determine a second waiting policy, which indicates no waiting after the speech capturing ends.

The client device 110 may, according to the second waiting policy, provide the captured first query speech segment and the captured first video segment to the target machine learning model in response to the capturing of the first query speech segment having ended and the waiting time after the end of the capturing of the first video segment reaching the predetermined time. The client device 110 may further provide, according to the second waiting policy, the captured first query speech segment and the captured first video segment to the target machine learning model in response to the waiting time after the end of the capturing of the first video segment not reaching the predetermined time when the capturing of the first query speech segment has ended. That is, no matter whether or not the time difference between the end of the capturing of the first query speech segment and the end of the capturing of the first video segment reaches the predetermined time, the client device 110 may directly provide the captured first query speech segment and the captured first video segment to the target machine learning model in response to the end of the capturing of the first query speech segment. This helps to ensure the integrity of the captured query speech and video, and helps to improve the response efficiency.

In some embodiments, if the capturing of the first video segment has ended before the capturing of the first query speech segment ends, the client device 110 may further determine the first waiting policy in response to determining that the second video segment is being captured at the end of the capturing of the first query speech segment, where the first waiting policy indicates waiting for the predetermined time after the video capturing ends. Similar to the case where the capturing of the first query speech segment has ended before the capturing of the first video segment ends, the client device 110 may start to wait after the capturing of the second video segment ends according to the first waiting policy. The client device 110 may provide the captured first query speech segment, the captured first video segment and the captured second video segment to the target machine learning model in response to the waiting time after the end of the capturing of the second video segment reaching the predetermined time and determining that no second query speech segment or third video segment is being captured. Therefore, if the capturing of multiple video segments is received during the capturing of the query speech, it may be determined that the multiple video segments are all associated with the query speech. In response to the capturing of the multiple video segments and the query speech all being ended, all the captured video segments and the query speech may be provided to the machine learning model, which may ensure the correlation between the video and the query speech, and help to improve the quality of the response.

As an example, referring to FIG. 3B, in the case that the end of the capturing of the query speech segment A is later than the end of the capturing of the video segment A, the client device 110 may determine that the current capturing scenario matches the capturing scenario shown in the block 304 in response to the capturing of the query speech segment A having not ended when the waiting time after the end of the capturing of the video segment A reaches the predetermined time, and in response to determining that no video segment B is being captured at the end of the capturing of the query speech segment A, and the time difference between the end of the capturing of the query speech segment A and the end of the capturing of the video segment A reaching the predetermined time. In the capturing scenario shown in the block 304, the client device 110 provides, according to the corresponding second waiting policy, the query speech segment A and the video segment A to the target machine learning model in response to the end of the capturing of the query speech segment A (that is, the time corresponding to the dotted line in the block 304 is reached).

In the case that the end of the capturing of the query speech segment A is later than the end of the capturing of the video segment A, the client device 110 may determine that the current capturing scenario matches the capturing scenario shown in the block 305 in response to the capturing of the query speech segment A having not ended when the waiting time after the end of the capturing of the video segment A reaches the predetermined time, and in response to determining that no video segment B is being captured at the end of the capturing of the query speech segment A, and the time difference between the end of the capturing of the query speech segment A and the end of the capturing of the video segment A not reaching the predetermined time. In the capturing scenario shown in the block 305, the client device 110 provides, according to the corresponding second waiting policy, the query speech segment A and the video segment A to the target machine learning model in response to the end of the capturing of the query speech segment A (that is, the time corresponding to the dotted line in the block 305 is reached).

In the case that the end of the capturing of the query speech segment A is later than the end of the capturing of the video segment A, the client device 110 may determine that the current capturing scenario matches the capturing scenario shown in the block 306 in response to the capturing of the query speech segment A having not ended when the waiting time after the end of the capturing of the video segment A reaches the predetermined time and in response to determining that the video segment B is being captured at the end of the capturing of the query speech segment A. In the capturing scenario shown in the block 305, the client device 110 may provide the captured query speech segment A, the captured video segment A and the captured video segment B to the target machine learning model according to the corresponding first waiting policy in response to no query speech segment B or video segment C (that is, the third video segment) being captured when the waiting time after the end of the capturing of the second video segment reaches the predetermined time (that is, the time corresponding to the dotted line in the block 306 is reached).

In some embodiments, the client device 110 may directly provide the captured video and the captured query speech to the target machine learning model. In some embodiments, the client device 110 may further determine a chat identification corresponding to the current interaction process of the capturing of the video and the query speech. The chat identification may include any appropriate identification such as a chat name, a chat ID, and a chat code. The chat identification is configured to identify and extract contextual information associated with the interaction process to provide to the target machine learning model together with the captured video segment. The client device 110 may provide at least the captured video to the target machine learning model together with the chat identification corresponding to the interaction process.

As mentioned above, the client device 110 may provide the information capturing interface shown in the example 300A. In the case of presenting the framing interface 320, the client device 110 may simultaneously capture the video and the query speech, and provide the response to the query speech to the user, where the response may be based on the video. This response scenario may be referred to as a multimodal response. In the case that the framing interface 320 is not presented, the client device 110 may only capture the query speech and provide the response to the query speech to the user, and this response scenario may be referred to as a single modality response. For example, the user may switch between the multimodal response and the single modality response by triggering the multimodal capturing control 311. In some embodiments, the response policy corresponding to the multimodal response and the response policy corresponding to the single modality response may be different response policies. For example, different machine learning models may be used to determine the multimodal response and the single modality response, respectively. In some cases, the machine learning model for determining the multimodal response and the machine learning model for determining the single modality response may maintain the contextual information required for response generation relatively independently.

In an example where time period A, time period B and time period C are adjacent time periods, with time period A being the earliest one and time period C being the latest one, if the user performs multimodal response with the digital assistant in time period A and time period C, performs single modality response with the digital assistant in time period B, and the time interval between time period A and time period C is less than a preset threshold, then the multimodal response performed in time period A and time period C may correspond to the same chat identification, and the single modality response performed in time period B may correspond to another chat identification.

In time period C, the client device 110 may provide the chat identification corresponding to the multimodal response and the video captured in time period C to the target machine learning model. The contextual information associated with the multimodal response performed in time period C may include, for example, information in the multimodal response performed in time period A (that is, the video, the query speech, the response, etc. captured in time period A).

It may be understood that the above is only an example. In some scenarios, regardless of the length of the time interval between time period A and time period C, in the case that both of them correspond to a multimodal response, both of them may correspond to the same chat identification. In some scenarios, if the time intervals between time period A, time period B and time period C are all less than the preset threshold, and the three time periods are sequentially linked, even if the three time periods correspond to responses of different modalities, the three time periods may still correspond to the same chat identification. The client device 110 may determine the chat information included in the chats with the same chat identification as the contextual information.

In some embodiments, the client device 110 may also extract a plurality of video frames from the captured video. The plurality of video frames may be randomly extracted or extracted based on a predetermined interval. For example, the client device 110 may extract one video frame from the captured video every 0.1 second. The client device 110 may directly provide the plurality of video frames and the query speech to the target machine learning model. The client device 110 may also store the plurality of video frames into an image storage platform, and the image storage platform may be any appropriate image storage platform. The image storage platform may be an image storage platform in the cloud. The client device 110 may obtain an access link corresponding to the plurality of stored video frames from the image storage platform, and provide the access link corresponding to the plurality of video frames and the query speech to the target machine learning model. For example, the target machine learning model may access the image storage platform in response to obtaining the access link, and obtain the plurality of video frames previously stored by the client device 110 from the image storage platform.

In some embodiments, the client device 110 may further perform speech recognition on the query speech to obtain a recognized text. The client device 110 may perform speech recognition on the query speech by means of an automatic speech recognition (ASR) model, and obtain the text corresponding to the query speech from the speech recognition model. The speech recognition model may be deployed locally on the client device 110 or on the server device 120. The client device 110 may provide the text obtained from the speech recognition model to the target machine learning model. That is, the client device 110 may provide the text and the video to the target machine learning model. In summary, the client device 110 may provide one of the following to the target machine learning model: query speech+video, query speech+video frames, query speech+access link, text+video, text+video frames, or text+access link.

At block 240, the client device 110 obtains a response to the query speech, where the response is determined based on at least a model output of the target machine learning model.

If the target machine learning model is a local machine learning model of the client device 110, the client device 110 may directly obtain the model output of the target machine learning model and determine the response based on the model output. If the target machine learning model is deployed on the server device 120, the server device 120 may obtain the model output and determine the response based on the model output. The client device 110 may then directly obtain the response from the server device 120. Alternatively, the server device 120 may also directly provide the model output to the client device 110, so that the client device 110 may determine the response on its own.

In some embodiments, the model output may be directly determined as the response to the query speech. In some embodiments, the model output may further be processed, and the processed model output may be determined as the response to the query speech. For example, the model output may be a response text in text form, and text-to-speech (TTS) may be performed on the response text to determine a response speech corresponding to the response text, and the response speech may be determined as the response corresponding to the query speech. It may be understood that the text-to-speech here is only an example of processing, and in practice, any appropriate manner may be used to determine the response based on the model output.

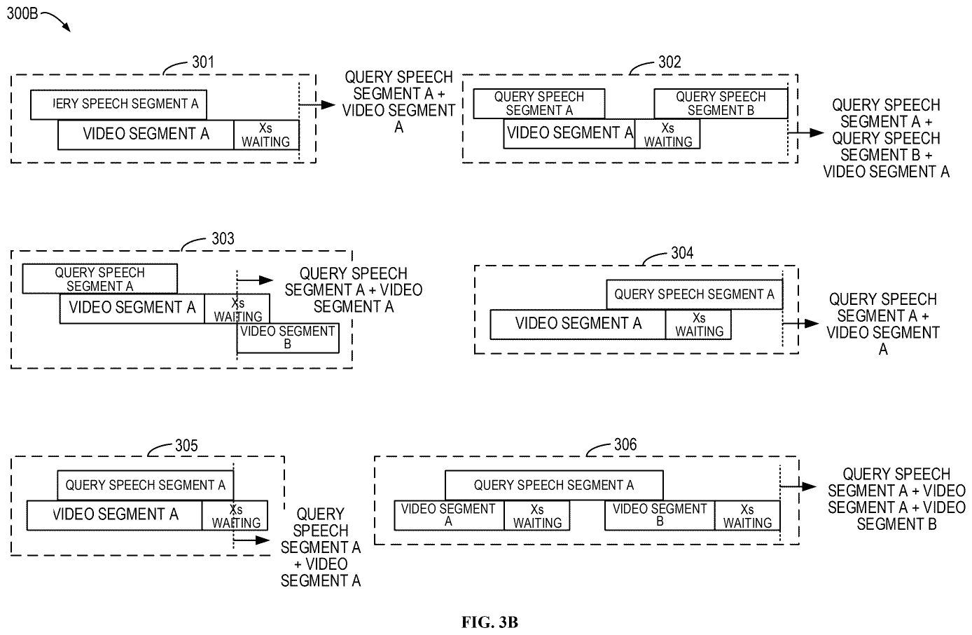

FIG. 4 shows an example architecture 400 for response provisioning according to some embodiments of the present disclosure. The client device 110 may capture a query speech 401 and a video 402 during an interaction process between the user 140 and the digital assistant. In the architecture of FIG. 4, the provision of response is completed in a collaborative manner between the client device 110 and the server device 120. However, the example architecture 400 of FIG. 4 is only shown as an example, and various modifications may be made in the actual application. For example, one or more components shown in FIG. 4 as being implemented in the server device 120 may also be implemented in the client device 110 or may be omitted. In some implementations, one or more components in the example architecture 400 may be omitted, or more components may be included. The embodiments of the present disclosure are not limited in this regard.

During the capturing of the video 402, the client device 110 may extract a plurality of video frames 403 from the captured video based on a predetermined interval. The client device 110 may store the plurality of video frames into an image storage platform 420 and obtain an access link corresponding to the plurality of stored video frames from the image storage platform 420. It may be understood that as the amount of captured video increases, the client device 110 may extract more video frames. The plurality of video frames may be stored in the same location of the image storage platform, for example, that is, the access link obtained by the client device 110 from the image storage platform 420 during the video capturing process may be the same link. Alternatively, different video frames may be stored in different locations and configured with different access links. Note that although FIG. 4 shows that the video frames are stored via the image storage platform 420, in other embodiments, the client device 110 may also directly upload the extracted video frames to the server device instead of uploading the access link.

During the capturing of the video 402, the client device 110 may provide the access link corresponding to the captured video and the chat identification corresponding to the interaction process together to an instant messaging (IM) link 430. The IM link 430 may provide the access link and the chat identification to a warm-up application programming interface (API) 440 of the server device 120. The warm-up API 440 may provide the access link and the chat identification to model engineering 470 via a model gateway 460. The model engineering 470 involves a model application framework 471 and a model service 472. The model engineering 470 may obtain a plurality of video frames 403 extracted from the captured video from the image storage platform 420 based on the access link, and may call a target machine learning model 480 to perform precoding on the plurality of video frames 403 to obtain a plurality of precomputed frames.

The client device 110 may further generate a video end identification (record end) in response to the end of the capturing of the video 402. In some embodiments, the client device 110 may also generate the video end identification in response to the capturing of the video 402 having ended, and a plurality of video frames 403 having been extracted from the video 402 and stored into the image storage platform 420. If a plurality of video segments are captured, the plurality of video segments may correspond to a plurality of video end identifications. The plurality of video segments may correspond to different access links.

An audio processing module 410 in the client device 110 may continuously upload the captured audio to a speech recognition model 415. In some embodiments, the speech recognition model 415 may provide a speech start identification (VAD start) to the audio processing module 410 in the client device 110 through speech activity detection (VAD) in response to starting to receive the captured audio, which means that a query speech may be captured subsequently. During the capturing process of the query speech 401, the query speech 401 is provided to the speech recognition model 415 to perform speech recognition by means of the speech recognition model 415. The client device 110 may obtain a text corresponding to the query speech 401 from the speech recognition model 415, and the text may be referred to as a query text. During the continuous audio capturing process, the speech recognition model 415 may further determine that the audio currently captured no longer contains speech content, and thus provide a speech end identification (VAD end) to the audio processing module 410 in the client device 110.

In this way, the audio captured between the speech start identification and the speech end identification is determined as a speech segment. If the user 140 triggers the speech for multiple times, a plurality of speech segments may be captured. This may also avoid subsequent processing on environmental sounds and noises between the speech segments. If one query speech segment is captured, the client device 110 may determine the text corresponding to the query speech as the text 412 in response to obtaining one speech end identification. If a plurality of query speech segments are captured, the client device 110 may concatenate texts corresponding to the plurality of query speech segments to obtain the text 412 in response to obtaining a plurality of speech end identifications.

The client device 110 may provide the text 412 to the IM link 430. The IM link 430 may provide the text 412 to a response API 450 of the server device 120. For example, the IM link 430 may determine a waiting policy based on the waiting policy determination solution described in the foregoing embodiments. When the waiting indicated by the waiting policy ends, he IM link 430 may provide the text 412 and the captured video frames (or the access link corresponding to the video frames) to the server device 120, so as to instruct the server device 120 to determine the model output based on the text 412 and the video frames obtained during the video capturing. In some embodiments, the access link corresponding to the video frames and the chat identification may be provided to the server device 120 via the warm-up API 440, and the text 412 may be provided to the server device 120 via the response API 450. Certainly, such a separate providing manner is only an example, and other manners may be used in practice.

The response API 450 in the server device 120 may provide the concatenated result to the model engineering 470 via the model gateway 460. The model engineering 470 may use the target machine learning model 480 to determine a model output for the text based on the plurality of video frames. It may be understood that the model output is also a model output for the query speech. In some embodiments, the model engineering 470 may directly use the plurality of precomputed frames determined during the video capturing to determine the model output for the text. In this case, the model engineering 470 does not need to encode the video frames again, and may directly call the pre-coded results, which may improve the efficiency of model calculation, thereby improving the efficiency of response.

After determining the model output, the model engineering 470 may provide the model output to the response API 450 via the model gateway 460. The response API 450 may send the model output to the IM link 430. The terminal device 110 may determine a response 404 based on the received model output and provide the response to the user.

To sum up, according to the embodiments of the present disclosure, in the multimodal response process, the waiting policy for the query speech and the video may be determined based on the relative temporal relationship between the end of the capturing of the query speech and the end of the capturing of the video. When the waiting indicated by the waiting policy ends, the target machine learning model may be used to determine the response to the query speech based on the captured query speech and video. This may ensure the correlation between the captured video and the query speech, as well as the respective integrities of the video and the query speech. It also helps to improve the efficiency and quality of the response.

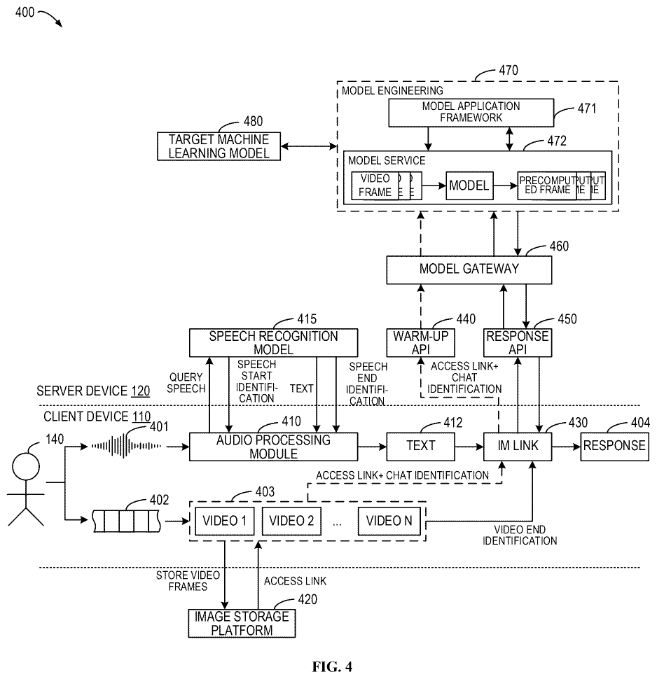

The embodiments of the present disclosure also provide a corresponding apparatus for implementing the above methods or processes. FIG. 5 shows an example structural block diagram of an apparatus 500 for response provisioning according to some embodiments of the present disclosure. The apparatus 500 may be implemented as or included in the client device 110 and/or the server device 120. Each module/component in the apparatus 500 may be implemented by hardware, software, firmware, or any combination thereof.

As shown in FIG. 5, the apparatus 500 includes a capturing module 510 configured to capture a query speech and a video during an interaction process. The apparatus 500 further includes a determination module 520 configured to determine a waiting policy for the query speech and the video based on a relative temporal relationship between an end of the capturing of the query speech and an end of the capturing of the video. The apparatus 500 further includes a providing module 530 configured to provide the captured query speech and the captured video to a target machine learning model upon an end of waiting indicated by the waiting policy. The apparatus 500 further includes an obtaining module 540 configured to obtain a response to the query speech, the response being determined based on at least a model output of the target machine learning model.

In some embodiments, the determination module 520 is further configured to determine a first waiting policy in response to capturing of a first query speech segment having ended before the end of the capturing of a first video segment, the first waiting policy indicating waiting for a predetermined time after video capturing ends.

In some embodiments, the providing module 530 is further configured to start to wait after the end of the capturing of the first video segment according to the first waiting policy; and provide the captured first query speech segment and the captured first video segment to the target machine learning model in response to a waiting time after the end of the capturing of the first video segment reaching the predetermined time and determining that neither a second query speech segment nor a second video segment is being captured.

In some embodiments, the determination module 520 is further configured to start to wait after the end of the capturing of the first video segment according to the first waiting policy; and determine a second waiting policy in response to detecting that a second query speech segment is being captured before a waiting time after the end of the capturing of the first video segment reaches the predetermined time, and determining, at an end of the capturing of the second query speech segment, that no second video segment is being captured, the second waiting policy indicating no waiting after speech capturing ends.

In some embodiments, the providing module 530 is further configured to provide, according to the second waiting policy, the captured first query speech segment, the captured second query speech segment and the captured first video segment to the target machine learning model after the end of the capturing of the second query speech segment.

In some embodiments, the determination module 520 is further configured to start to wait after the end of the capturing of the first video segment according to the first waiting policy; and determine a third waiting policy in response to detecting that a second video segment is being captured before a waiting time after the end of the capturing of the first video segment reaches the predetermined time, the third waiting policy indicating interrupting the waiting for the predetermined time at a start of the capturing of the second video segment.

In some embodiments, the providing module 530 is further configured to provide the captured first query speech segment and the captured first video segment to the target machine learning model at the start of capturing of the second video segment according to the third waiting policy.

In some embodiments, the determination module 520 is further configured to determine a second waiting policy in response to capturing of a first video segment having ended before capturing of a first query speech segment ends, the capturing of the first query speech segment has not ended when a waiting time after the end of the capturing of the first video segment reaches a predetermined time, and determining that no second video segment is being captured at the end of the capturing of the first query speech segment, the second waiting policy indicating no waiting after speech capturing ends.

In some embodiments, the providing module 530 is further configured to provide, according to the second waiting policy, the captured first query speech segment and the captured first video segment to the target machine learning model in response to the capturing of the first query speech segment having ended and a waiting time after the end of the capturing of the first video segment reaching the predetermined time; and provide, according to the second waiting policy, the captured first query speech segment and the captured first video segment to the target machine learning model in response to the waiting time after the end of the capturing of the first video segment not reaching the predetermined time when the capturing of the first query speech segment has ended.

In some embodiments, the determination module 520 is further configured to determine a first waiting policy in response to capturing of a first video segment having ended before capturing of a first query speech segment ends and determining that a second video segment is being captured at an end of the capturing of the first query speech segment, the first waiting policy indicating waiting for the predetermined time after video capturing ends.

In some embodiments, the providing module 530 is further configured to start to wait after the end of the capturing of the second video segment according to the first waiting policy; and provide the captured first query speech segment, the captured first video segment and the captured second video segment to the target machine learning model in response to a waiting time after the end of the capturing of the second video segment reaching the predetermined time and determining that neither a second query speech segment nor a third video segment is being captured.

In some embodiments, the providing module 530 is further configured to provide the captured video to the target machine learning model together with a chat identification corresponding to the interaction process; where the chat identification is configured to identify and extract contextual information associated with the interaction process to provide to the target machine learning model together with the captured video segment.

In some embodiments, the providing module 530 is further configured to extract a plurality of video frames from the captured video based on a predetermined interval; store the plurality of video frames into an image storage platform; obtain an access link corresponding to the plurality of stored video frames from the image storage platform; and provide the access link corresponding to the plurality of video frames to the target machine learning model.

In some embodiments, the providing module 530 is further configured to perform speech recognition on the query speech to obtain a recognized text; and provide the text to the target machine learning model.

The units and/or modules included in the apparatus 500 may be implemented in various manners, including software, hardware, firmware, or any combination thereof. In some embodiments, one or more units and/or modules may be implemented using software and/or firmware, for example, machine-executable instructions stored on a storage medium. In addition to machine-executable instructions or as an alternative, some or all units and/or modules in the apparatus 500 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

It should be understood that one or more steps of the above method may be performed by a suitable electronic device or a combination of electronic devices. Such an electronic device or a combination of electronic devices may include, for example, the client device 110 and/or the server device 120 in FIG. 1.

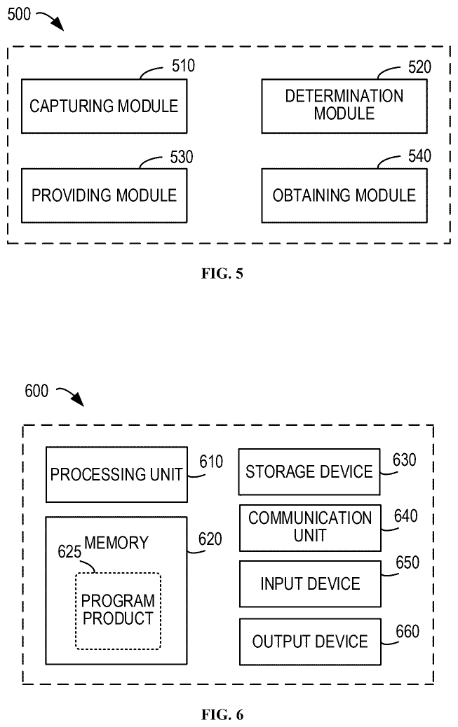

FIG. 6 shows a block diagram of an electronic device 600 in which one or more embodiments of the present disclosure can be implemented. It should be understood that the electronic device 600 shown in FIG. 6 is only example, and should not constitute any limitation on the function and scope of the embodiments described herein. The electronic device 600 shown in FIG. 6 may be used to implement the client device 110 and/or the server device 120 in FIG. 1.

As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be a physical or virtual processor, and may perform various processes based on the programs stored in the memory 620. In a multiprocessor system, multiple processing units execute computer-executable instructions in parallel to improve the parallel processing capability of the electronic device 600.

The electronic device 600 typically includes multiple computer storage medium. Such medium may be any available medium that is accessible to the electronic device 600, including, but not limited to, volatile and non-volatile medium, removable and non-removable medium. The memory 620 may be volatile memory (for example, a register, cache, Random Access Memory (RAM)), a non-volatile memory (such as a Read-Only Memory (ROM), Electrically Erasable Programmable Read-Only Memory (EEPROM), flash memory), or any combination thereof. The storage device 630 may be a removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, a disk driver for reading from or writing to a removable, non-volatile disk (such as a “floppy disk”), and an optical disk driver for reading from or writing to a removable, non-volatile optical disk may be provided. In these cases, each driver may be connected to a bus (not shown) by one or more data medium interfaces. The memory 620 may include a computer program product 625, which has one or more program modules configured to perform various methods or acts of various embodiments of the present disclosure.

The communication unit 640 implements communication with other electronic devices through the communication medium. In addition, the functions of the components of the electronic device 600 may be implemented by a single computing cluster or multiple computing machines, which may communicate through a communication connection. Therefore, the electronic device 600 may use a logical connection with one or more other servers, a network personal computer (PC) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) through the communication unit 640 as needed. The external devices include a storage device, a display device, etc. The electronic device 600 communicates with one or more devices that enable the user to interact with the electronic device 600, or communicates with any devices (such as a network card, a modem, etc.) that enable the electronic device 600 to communicate with one or more other electronic devices. Such communication may be performed via an input/output (I/O) interface (not shown).

According to an example implementation of the present disclosure, a computer-readable storage medium is provided, on which computer-executable instructions are stored. The computer-executable instructions are executed by a processor to implement the method described above. According to an example implementation of the present disclosure, there is further provided a computer program product, which is tangibly stored on a non-transitory computer-readable medium and includes computer-executable instructions. The computer-executable instructions are executed by a processor to implement the method described above.

Various aspects of the present disclosure are described herein with reference to flowcharts and/or block diagrams of methods, apparatuses, devices and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that when these instructions are executed by the processing unit of the computer or other programmable data processing apparatus, an apparatus for implementing the functions/actions specified in one or more blocks of the flowcharts and/or block diagrams is produced. These computer-readable program instructions may also be stored in a computer-readable storage medium, and these instructions cause the computer, the programmable data processing apparatus, and/or other devices to work in a specific manner. Thus, the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, other programmable data processing apparatus, or other devices, such that a series of operating steps are performed on the computer, other programmable data processing apparatus, or other devices to produce a computer-implemented process. Thus, the instructions executed on the computer, other programmable data processing apparatus, or other devices implement the functions/actions specified in one or more blocks of the flowcharts and/or block diagrams.

The flowcharts and block diagrams in the drawings show the possibly implemented architectures, functions and operations of the systems, methods and computer program products according to multiple implementations of the present disclosure. In this regard, each block in the flowchart or block diagram may represent a module, program segment or part of instructions, which contains one or more executable instructions for implementing the specified logical functions. In some updated implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform the specified functions or actions, or may be implemented by a combination of special-purpose hardware and computer instructions.

The implementations of the present disclosure have been described above. The above description is example, non-exhaustive, and is not limited to the disclosed implementations. Without departing from the scope and spirit of the described implementations, many modifications and changes will be apparent to those of ordinary skill in the art. The terms used herein are selected to best explain the principles of the implementations, the practical applications, or improvements to the technologies in the market, or to enable other those of ordinary skill in the art to understand the implementations disclosed herein.

I/We claim:

1. A method for response provisioning, comprising:
capturing a query speech and a video during an interaction process;
determining a waiting policy for the query speech and the video based on a relative temporal relationship between an end of the capturing of the query speech and an end of the capturing of the video;
providing the captured query speech and the captured video to a machine learning model upon an end of waiting indicated by the waiting policy; and
obtaining a response to the query speech, the response being determined based on at least a model output of the machine learning model.

2. The method of claim 1, wherein determining the waiting policy for the query speech and the video comprises:
determining a first waiting policy in response to capturing of a first query speech segment having ended before the end of the capturing of a first video segment, the first waiting policy indicating waiting for a predetermined time after video capturing ends.

3. The method of claim 2, wherein providing the captured query speech and the captured video to the machine learning model comprises:
starting to wait after the end of the capturing of the first video segment according to the first waiting policy; and
providing the captured first query speech segment and the captured first video segment to the machine learning model in response to a waiting time after the end of the capturing of the first video segment reaching the predetermined time and determining that neither a second query speech segment nor a second video segment is being captured.

4. The method of claim 2, wherein determining the waiting policy for the query speech and the video further comprises:
starting to wait after the end of the capturing of the first video segment according to the first waiting policy; and
determining a second waiting policy in response to detecting that a second query speech segment is being captured before a waiting time after the end of the capturing of the first video segment reaches the predetermined time, and determining, at an end of the capturing of the second query speech segment, that no second video segment is being captured, the second waiting policy indicating no waiting after speech capturing ends.

5. The method of claim 4, wherein providing the captured query speech and the captured video to the machine learning model comprises:
providing, according to the second waiting policy, the captured first query speech segment, the captured second query speech segment and the captured first video segment to the machine learning model after the end of the capturing of the second query speech segment.

6. The method of claim 2, wherein determining the waiting policy for the query speech and the video further comprises:
starting to wait after the end of the capturing of the first video segment according to the first waiting policy; and
determining a third waiting policy in response to detecting that a second video segment is being captured before a waiting time after the end of the capturing of the first video segment reaches the predetermined time, the third waiting policy indicating interrupting the waiting for the predetermined time at a start of the capturing of the second video segment.

7. The method of claim 6, wherein providing the captured query speech and the captured video to the machine learning model comprises:
providing the captured first query speech segment and the captured first video segment to the machine learning model at the start of capturing of the second video segment according to the third waiting policy.

8. The method of claim 1, wherein determining the waiting policy for the query speech and the video comprises:
determining a second waiting policy in response to capturing of a first video segment having ended before capturing of a first query speech segment ends, the capturing of the first query speech segment has not ended when a waiting time after the end of the capturing of the first video segment reaches a predetermined time, and determining that no second video segment is being captured at the end of the capturing of the first query speech segment, the second waiting policy indicating no waiting after speech capturing ends.

9. The method of claim 8, wherein providing the captured query speech and the captured video to the machine learning model comprises:
providing, according to the second waiting policy, the captured first query speech segment and the captured first video segment to the machine learning model in response to the capturing of the first query speech segment having ended and a waiting time after the end of the capturing of the first video segment reaching the predetermined time; and
providing, according to the second waiting policy, the captured first query speech segment and the captured first video segment to the machine learning model in response to the waiting time after the end of the capturing of the first video segment not reaching the predetermined time when the capturing of the first query speech segment has ended.

10. The method of claim 1, wherein determining the waiting policy for the query speech and the video further comprises:
determining a first waiting policy in response to capturing of a first video segment having ended before capturing of a first query speech segment ends and determining that a second video segment is being captured at an end of the capturing of the first query speech segment, the first waiting policy indicating waiting for the predetermined time after video capturing ends.

11. The method of claim 10, wherein providing the captured query speech and the captured video to the machine learning model comprises:
starting to wait after the end of the capturing of the second video segment according to the first waiting policy; and
providing the captured first query speech segment, the captured first video segment and the captured second video segment to the machine learning model in response to a waiting time after the end of the capturing of the second video segment reaching the predetermined time and determining that neither a second query speech segment nor a third video segment is being captured.

12. The method of claim 1, wherein providing the captured video to the machine learning model comprises:
providing the captured video to the machine learning model together with a chat identification corresponding to the interaction process,
wherein the chat identification is configured to identify and extract contextual information associated with the interaction process to provide to the machine learning model together with the captured video segment.

13. The method of claim 1, wherein providing the captured video to the machine learning model comprises:
extracting a plurality of video frames from the captured video based on a predetermined interval;
storing the plurality of video frames into an image storage platform;
obtaining an access link corresponding to the plurality of stored video frames from the image storage platform; and
providing the access link corresponding to the plurality of video frames to the machine learning model.

14. The method of claim 1, wherein providing the captured query speech to the machine learning model comprises:
performing speech recognition on the query speech to obtain a recognized text; and
providing the text to the machine learning model.

15. An electronic device, comprising:
at least one processor; and
at least one memory coupled to the at least one processor and storing instructions for execution by the at least one processor, the instructions, when executed by the at least one processor, causing the electronic device to perform operations comprising:
capturing a query speech and a video during an interaction process;
determining a waiting policy for the query speech and the video based on a relative temporal relationship between an end of the capturing of the query speech and an end of the capturing of the video;
providing the captured query speech and the captured video to a machine learning model upon an end of waiting indicated by the waiting policy; and
obtaining a response to the query speech, the response being determined based on at least a model output of the machine learning model.

16. The electronic device of claim 15, wherein determining the waiting policy for the query speech and the video comprises:
determining a first waiting policy in response to capturing of a first query speech segment having ended before the end of the capturing of a first video segment, the first waiting policy indicating waiting for a predetermined time after video capturing ends.

17. The electronic device of claim 16, wherein providing the captured query speech and the captured video to the machine learning model comprises:
starting to wait after the end of the capturing of the first video segment according to the first waiting policy; and
providing the captured first query speech segment and the captured first video segment to the machine learning model in response to a waiting time after the end of the capturing of the first video segment reaching the predetermined time and determining that neither a second query speech segment nor a second video segment is being captured.

18. The electronic device of claim 16, wherein determining the waiting policy for the query speech and the video further comprises:
starting to wait after the end of the capturing of the first video segment according to the first waiting policy; and
determining a second waiting policy in response to detecting that a second query speech segment is being captured before a waiting time after the end of the capturing of the first video segment reaches the predetermined time, and determining, at an end of the capturing of the second query speech segment, that no second video segment is being captured, the second waiting policy indicating no waiting after speech capturing ends.

19. The electronic device of claim 15, wherein determining the waiting policy for the query speech and the video comprises:
determining a second waiting policy in response to capturing of a first video segment having ended before capturing of a first query speech segment ends, the capturing of the first query speech segment has not ended when a waiting time after the end of the capturing of the first video segment reaches a predetermined time, and determining that no second video segment is being captured at the end of the capturing of the first query speech segment, the second waiting policy indicating no waiting after speech capturing ends.

20. A non-transitory computer-readable storage medium having a computer program stored thereon, the computer program being executable by a processor to implement operations comprising:
capturing a query speech and a video during an interaction process;
determining a waiting policy for the query speech and the video based on a relative temporal relationship between an end of the capturing of the query speech and an end of the capturing of the video;
providing the captured query speech and the captured video to a machine learning model upon an end of waiting indicated by the waiting policy; and
obtaining a response to the query speech, the response being determined based on at least a model output of the machine learning model.
